(19) United States
(12) Patent Application Publication
(10) Pub. No.: US 2008/0272649 A1
(43) Pub. Date: Nov. 6, 2008

(54) Electrical connectivity system for use in a vehicle

(75) Inventors: Kim L. Van Order, Hamilton, MI (US); Eric S. Deuel, Allendale, MI (US); Lance M. Hilbelink, Jenison, MI (US); Leif Norland, Holland, MI (US); Scott T. Williams, Holland, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 10/977,476

(22) Filed: Oct. 29, 2004

Related U.S. Application Data
(60) Provisional application No. 60/515,980, filed on Oct. 31, 2003.

(51) Int. Cl. B60L 1/00; G06F 13/42

(52) U.S. Cl. 307/10.1; 340/825

(57) ABSTRACT

An electrical connectivity system for use in a vehicle includes a first plurality of electrical devices a first plurality of electrical devices coupled to at least one utility carrier and a control module coupled to the at least one utility carrier. The first plurality of electrical devices are configured to communicate a plurality of utilities on the at least one utility carrier. The control module is also coupled to a second plurality of electrical devices and is configured to control the selection and distribution of the plurality of utilities to the second plurality of electrical devices. The control module includes a user interface configured to receive user input commands regarding the selection of utilities distributed to the second plurality of electrical devices. The control module and second plurality of electrical devices may be mounted to a modular system in the vehicle.

### PRIORITY

This application claims the benefit of U.S. Provisional Patent Application No. 60/515,980, filed Oct. 31, 2003, titled “Electrical Connectivity System For a Vehicle,” hereby incorporated by reference in its entirety.

### FIELD OF THE INVENTION

The present invention relates to electrical devices and modular systems for a vehicle and, in particular, to an electrical connectivity system for a distributing data, audio, video and command/control information to electrical devices in a vehicle and for control of electrical devices in a vehicle.

### BACKGROUND OF THE INVENTION

Modular storage compartments in the forward portion of a vehicle are generally known and include consoles and structures for mounting items such as lamps, small storage compartments and electronic instrumentation such as compasses, temperature displays and clocks. Such modular systems typically have mounting configurations that permanently attach such articles to a structural portion of the vehicle, whereby installation of article options are typically conducted in a factory setting during vehicle construction and often requires user-selection of the desired articles prior to vehicle assembly, or user acceptance of preinstalled option packages. Typically, each electrical article or device attached to a modular system or located elsewhere in the vehicle is controlled separately by an occupant of the vehicle (e.g., a driver or passenger). For example, each article may include a user interface (e.g., buttons, display, etc.) used to select and/or control the operation of the article. In addition utilities (e.g., power, data, audio, video, control signals, etc.) need to be distributed to each electrical article attached to a modular system or located elsewhere in the vehicle.

Accordingly, it would be advantageous to provide a modular system for interchangeably mounting a wide array of selectively removable, user-oriented articles that are adapted for use within, or in conjunction with, a vehicle. It would also be advantageous to provide a control module that is configured to provide a single point of control and a user interface for multiple electrical articles in a vehicle, such as electrical articles mounted to a modular system. It would also be advantageous to provide an electrical connectivity system to distribute or communicate utilities such as power, data, audio, video and/or command and control signals to and/or between electrical devices in a vehicle.

### SUMMARY

In accordance with an embodiment, an electrical connectivity system for use in a vehicle includes a first plurality of electrical devices coupled to at least one utility carrier, the first plurality of electrical devices configured to communicate a plurality of utilities on the at least one utility carrier and a control module coupled to the at least one utility carrier and a second plurality of electrical devices and configured to control the selection and distribution of the plurality of utilities to the second plurality of electrical devices. The control module includes a user interface configured to receive user input commands regarding the selection of utilities distributed to the second plurality of electrical devices. The second plurality of electrical devices may be mounted to a modular system in the vehicle. The control module may also be mounted to a modular system in the vehicle. The plurality of utilities may include, for example, data signals, audio signals or video signals. The control module may be further configured to control the delivery of utility signals between the second plurality of electrical devices and the first plurality of electrical devices.

In accordance another embodiment, an electrical connectivity system for use in a vehicle includes a first plurality of electrical devices coupled to at least one utility carrier where the first plurality of electrical devices are configured to communicate a plurality of utilities on the at least one utility carrier. The system also includes a control module coupled to the at least one utility carrier and a second plurality of electrical devices. The control module is configured to control the operation of each device in the second plurality of electrical devices and includes a user interface configured to receive user input commands regarding the operation of at least one device of the second plurality of electrical devices. The control module may be further configured to control the distribution of the plurality of utilities to the second plurality of electrical devices. The plurality of utilities may include, for example, power, data signals, audio signals, video signals or control signals. In one embodiment, the second plurality of electrical devices are mounted to a modular system in the vehicle. The control module may also be mounted to a modular system in the vehicle. In another embodiment, the first plurality of electrical devices includes a power source and the at least one utility carrier includes a utility carrier for power.

In accordance with yet another embodiment, a system for transmission of multiple analog audio signals in a vehicle includes a first audio device, a first multiplexer module coupled to the first audio device and configured to combine a plurality of analog audio signals into a multi-channel audio signal, a single wire audio bus coupled to the first multiplexer module and configured to carry the multi-channel audio signal provided by the first multiplexer module, and a second multiplexer module coupled to the single wire audio bus and a second audio device, the second multiplexer module configured to receive the multi-channel audio signal, separate the plurality of analog audio signals in the multi-channel audio signal and provide at least one analog audio signal to the second audio device. In one embodiment, the single wire audio bus is further configured to bi-directionally communicate analog audio signals between the first audio device and the second audio device. Each channel of the multi-channel audio signal may be defined to communicate audio signals in a direction. In another embodiment, the first multiplexer module includes a first multiplexer/demulitplexer circuit. The second multiplexer module may include a second multiplexer/demulitplexer circuit.

In accordance with a further embodiment, a method for providing electrical connections in a modular system in a vehicle, the modular system including one or more elongated members adapted to be coupled to an interior portion of the vehicle includes providing a plurality of conductive segments on each elongated member and providing a plurality of non-conductive segments on each elongated member.

### BRIEF DESCRIPTION OF THE DRAWINGS

The invention will be more readily understood by reference to the following description taken with the accompanying drawings, in which:

FIG. 1 is an upward-looking perspective view of a modular system mounted on a vehicle interior in accordance with an embodiment.

FIG. 2A is an upward looking perspective view of a modular system with end cover trim pieces in accordance with an embodiment.

FIG. 2B is an upward looking perspective view of a modular system with end cover trim pieces removed in accordance with an embodiment.

FIG. 3 is a downward looking perspective view of a modular system in accordance with an embodiment.

FIG. 4 is a side elevation of a modular system in accordance with an embodiment.

FIG. 5 is an upward looking bottom view of a modular system in accordance with an embodiment.

FIG. 6 is a cross sectional view of a modular system along line 6-6 of FIG. 3 in accordance with an embodiment.

FIG. 7A is a cross-sectional view of a member of a modular system with segmented electrical portions in accordance with an embodiment.

FIG. 7B is a perspective view of a member of a modular system with segmented electrical portion in accordance with an embodiment.

FIG. 8 is a block diagram of an electrical connectivity system in accordance with an embodiment.

FIG. 9 is a block diagram of an electrical connectivity system in accordance with an alternative embodiment.

FIG. 10 shows an exemplary user interface for a control module of the electrical connectivity system of FIGS. 8 and 9 in accordance with an embodiment.

FIG. 11 is a block diagram of an analog audio transmission system in accordance with an embodiment.

### DESCRIPTION OF PREFERRED EMBODIMENTS

Vehicles typically include a plurality of electrical devices/articles such as a radio, a CD player, a DVD player, a clock, a compass, a navigation system, etc. These electrical devices may be located throughout the vehicle. For example, a radio may be installed at the front of the vehicle in a dashboard as part of a radio head, a DVD player may be mounted to the roof or floor of a vehicle, a CD player may be installed in a trunk or glove compartment of the vehicle, or a compass may be located in a rear view mirror of a vehicle. In addition, a modular system, such as described herein, may be provided in a vehicle for interchangeably mounting one or more selectively removable articles, including electrical articles in the vehicle. In order to operate the electrical devices in a vehicle, power must be provided to the electrical devices at various locations within the vehicle. In addition, data, audio, video and/or command and control signals may be distributed to and/or between electrical devices or articles in the vehicle. For example, the audio signals from a CD player (e.g., located in a trunk or mounted to a modular system in the vehicle) may be communicated to an audio system in the vehicle so that the sound from the CD player may be heard over the vehicle speakers.

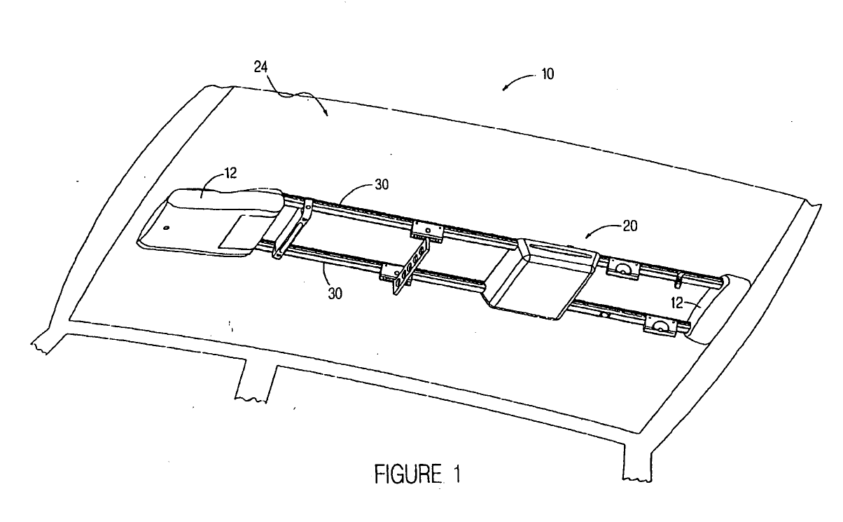

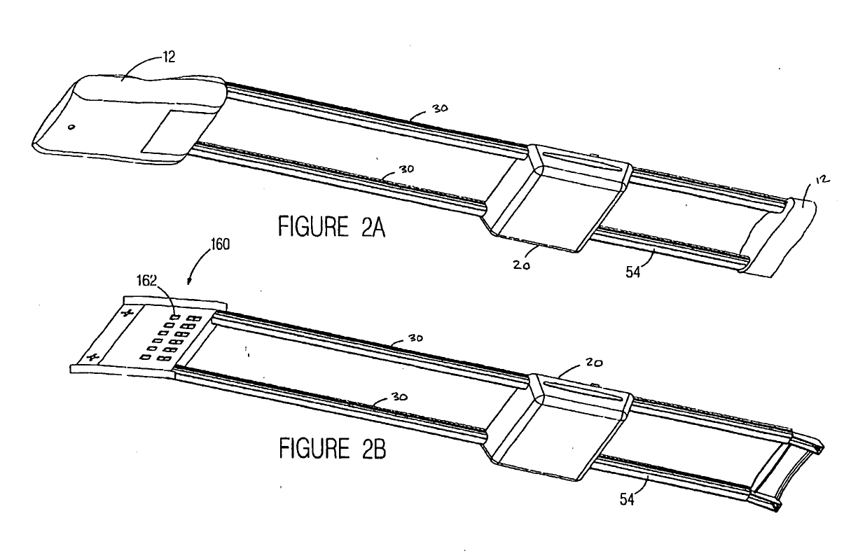

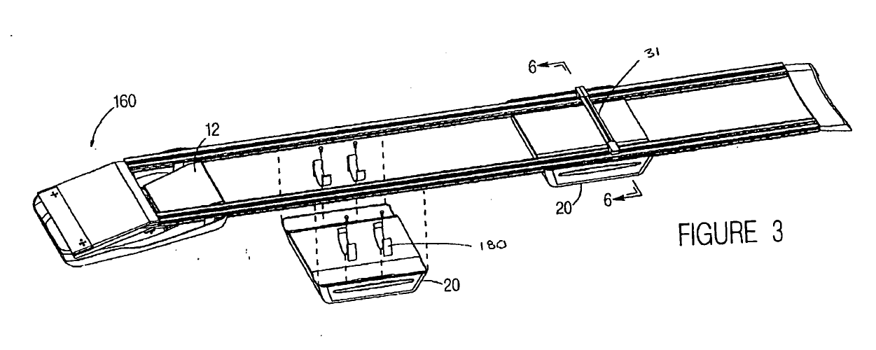

As mentioned above, a modular system may be provided in a vehicle so that additional articles, including electrical devices, may be installed in the vehicle. Referring to FIGS. 1 and 2, a modular system 10 for mounting one or more articles 20 is shown schematically (exemplary articles will be further described herein) along an interior panel 24 (e.g. door or side panel, cover, headliner, etc.) of a vehicle according to a preferred embodiment. System 10 may also be adapted for mounting articles 20 along the sides of the vehicle such as door or side panels, or within the interior space of the vehicle such as cargo areas, in a manner similar to the method described herein. System 10 includes two generally parallel mounting members 30 such as rails, tracks, channels, holders, bars, rods, poles, etc. that are oriented in any desired configuration within a vehicle along interior panel 24. Members 30 have a lateral spacing that is generally fixed for a particular vehicle style, but the spacing may vary between different vehicle styles and models and may have any lateral spacing suitable for mounting articles 20. One or more positioners 31 shown schematically in FIG. 3 may be used to secure the lateral spacing of members 30 for receiving articles 20. For overhead applications, members 30 may be oriented longitudinally, centered laterally within the vehicle, but may be located at any lateral position on the interior panel 24 to accommodate mounting of articles 20. In an alternative embodiment, members 30 may be separated into a forward segment and/or a rearward segment (not shown) for adapting to roof windows or other discontinuities in the roof structures. Members 30 may also be oriented laterally along interior panel 24 to increase the flexibility and utility of the system for interchangeably receiving the articles 20. In another alternative embodiment, a single member 30 may be used in conjunction with articles 20 that are adapted to selectively and interchangeably engage a single member 30. In a further alternative embodiment, members 30 may be mounted to pillars (not shown) or other generally vertical support columns within the interior space of a vehicle to provide a system for attaching articles 20. Such pillars may be secured by articles mounted to the members 30 for increased flexibility in attaching articles to the pillar-mounted members.

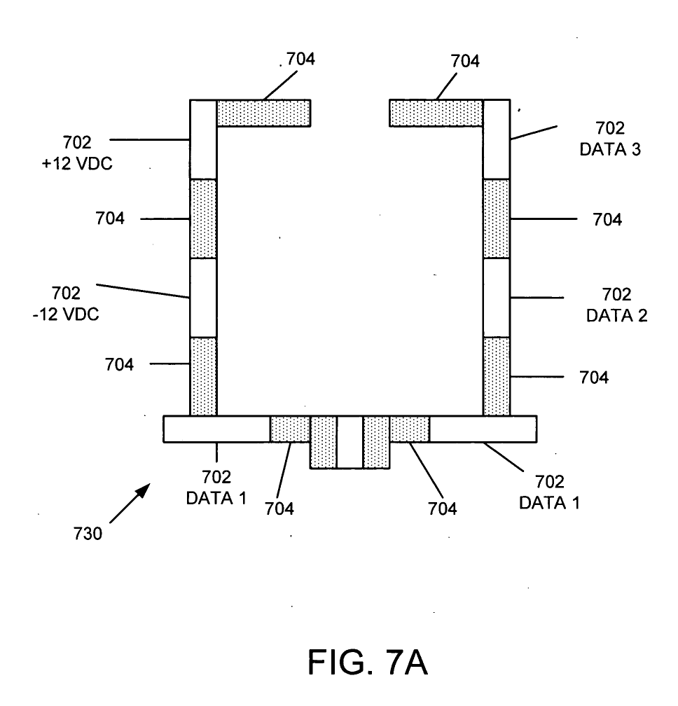

Referring to FIG. 6, the structural shape of members 30 are shown according to a preferred embodiment. Members 30 have a generally hollow cross sectional shape as shown in FIG. 6, and include a generally flat base 32 (e.g. back, contact surface, etc.) on the top of member 30 with several longitudinal ribs 34 projecting therefrom. Ribs 34 are provided at the outside edges to grip the surface of interior panel 24 and a pair of ribs 34 are located centrally for alignment with connectors 160 or 60 when members 30 are secured to the roof structure. Members 30 further include integral sides 36 having a recess 38 (e.g. notch, inset, slot, groove, channel, etc.) forming an outwardly projecting supporting ledge 40 (e.g. corner, shoulder, edge, etc.). Recesses 38 and ledges 40 provide an external structure for receiving and supporting the articles 20 (shown schematically) having corresponding structure adapted to mate with ledges 40. In a particularly preferred embodiment, ledge 40 is horizontal (as shown) and ledge 40 and recess 38 are formed having an angle of 90 degrees or less for providing a structure for receiving articles 20. In an alternative embodiment, member 30 may have a circular cross sectional shape (not shown) or any other shape where the exterior surface is configured to provide longitudinal recesses and ledges similar to recesses 38 and ledges 40 for receiving and supporting the articles 20. In another alternative embodiment, member 30 may have a second recess and ledge (not shown) for providing an alternative article mounting interface and providing structure adaptable for mounting interlocks that may prohibit or allow installation of certain articles along particular locations of members 30.

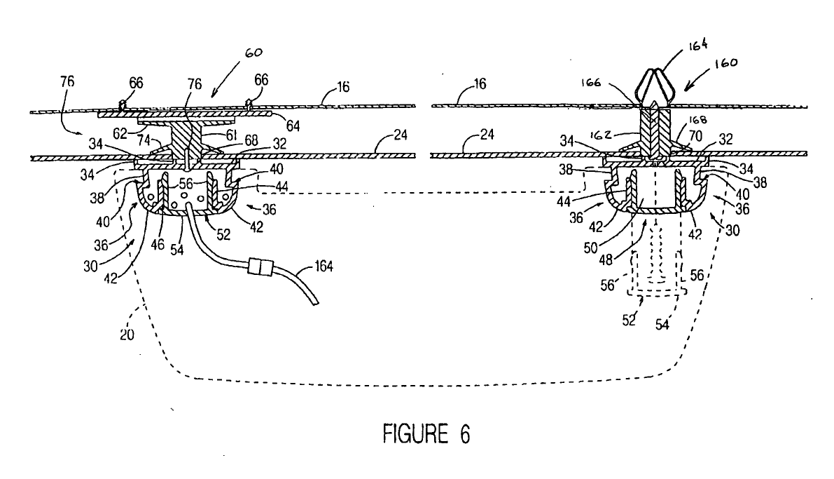

Beneath ledges 40, sides 36 include inwardly curved lower sections 42 that terminate into a return bend 44 providing internal corners 46 to create a longitudinal opening 48. Opening 48 creates a passage 50 (e.g. channel, path, conduit, tunnel, etc.) within members 30 for routing utility carriers such as wires, cables, fiber optics, etc. as shown schematically in FIGS. 5 and 6. A removable cap 52 is provided generally along the entire length of member 30 having a cover 54 to cover opening 48 and retain utility carriers, and may have a flush fit with member 30, or may have projecting contours, ribs, or other decorative or useful structure (not shown). Cap 52 includes two inwardly projecting legs 56 that fit within opening 48 and are removably retained in place by an interference type, snap-fit engagement with return bends 44. Opening 48 may be entirely or partially concealed by inserting one or more caps 52 having segments of various lengths tailored to create an access pattern within members 30. The access pattern may be created or modified at any time for selectively providing access to opening 48 along the length of member 30. Member 30 and cap 52 are preferably made of acrylonitrile butiadene styrene (ABS) plastic in an extrusion process, and may be provided in a wide variety of colors designed to accent an interior trim color scheme. Alternatively, members 30 and cap 52 may be made of aluminum or any other suitable material, wherein members 30 or cap 52 may also serve as a conductor for transmitting low voltage electrical power from a vehicle supply source to articles 20 mounted on members 30. The outer surface of the aluminum members is preferably anodized which provides an insulating layer on the exterior of the member, which may be selectively removed to provide a custom-tailored electrical conductivity access pattern. Portions of members 30 and cap 52 that are not otherwise enclosed by articles 20 may also have a separate insulating cover (not shown) that snap fits into recesses 38 and ledges 40 to electrically isolate members 30 from consumer contact or inadvertent contact with an electrical ground. Members 30 and cap 52 may also be made of any other material suitable for forming an elongated support member and receiving mounting structure from articles 20 to be supported therefrom.

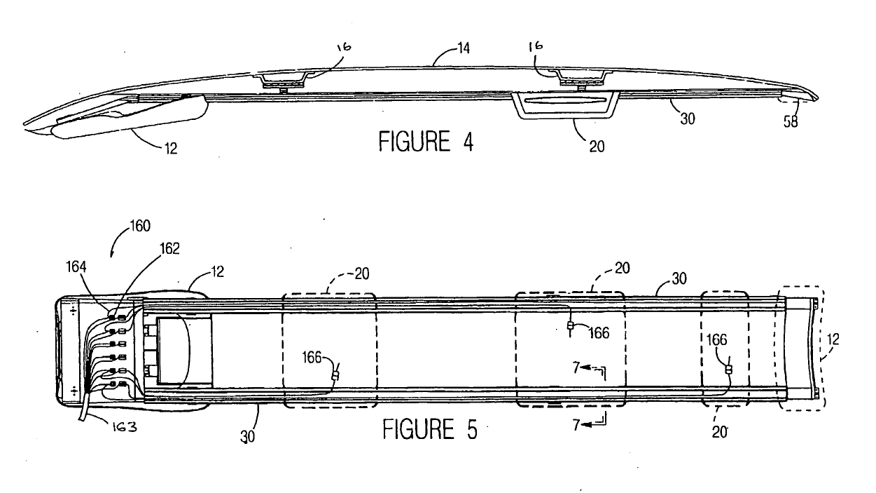

Referring to FIG. 4, members 30 are secured to the vehicle according to a preferred embodiment. The ends of members 30 are rigidly attached to the forward and rearward edges of the roof frame (e.g. beams, headers, bows, cross-pieces, etc.—not shown) by welding, brazing or fastening with conventional fasteners (not shown). Members 30 may have ends attached directly to the frame, or members 30 may be attached to the roof frame via fixtures shown schematically as brackets 58. Brackets may also be provided to support the ends of member segments that abut a roof discontinuity such as a sunroof, etc. The forward and rearward end connections of members 30 are covered by suitable trim components shown schematically as a bezel or molding 12. Members 30 may have a side profile that is straight, or a side profile that is slightly curved or bowed (not shown) to correspond with the panel profile 14 (shown as a roof panel). In an alternative embodiment, members 30 may be secured to door panel structures (not shown) or to pillars or other support columns (not shown) within the interior of the vehicle. Such support columns may be permanently fixed to the interior vehicle structure or may be removably or retractably attached to vehicle structure such as the floor, roof or sides of the vehicle to create a modular system for attaching articles within any interior location of a vehicle.

Referring further to FIGS. 4 and 6, a structural support system for the interior span of members 30 is shown according to a preferred embodiment. The interior span of members 30 are coupled to the roof structure of the vehicle using connectors 160 (e.g. Z-axis clips) having a spacer portion 162 with spring clip 164. Fastener 166 may be used to secure member 30 to spacer portion 162 and for securing spacer portion 162 to spring clip 164 to ensure the structural integrity of system 10. Spacer portion 162 may project through an aperture 70 in panel 24 to provide secure abutment with the back of member 30, and supports 168 may project outwardly from spacer portion 162 to provide support to panel 24 around aperture 70. Connectors 160 are attached to one or more lateral frame members 16 (e.g. beams, roof bows, door panels, floor panels, cross headers, etc.) at a lateral position along frame member 16 corresponding to the installation position of members 30. An alternative connector type may also be used such as that shown by connector 60 in FIG. 6. Connectors 60 have a spacer portion 61 and a base portion 62 coupled to a platform 64 that is attached to frame member 16 by finned-plugs 66 (e.g., “Christmas tree connectors”) or by a structural adhesive (not shown) such as “BETAMATE 73705” which is a polyurethane adhesive manufactured by the Dow Chemical Corporation and available through Sound Alliance, LLC located in Auburn Hills, Mich. In an alternative embodiment, connectors 60 may be attached to frame member 16 by a two-piece reclosable fastener system (not shown) such as “DUAL LOCK”® having mushroom-head shaped projections and manufactured by the Minnesota Mining and Manufacturing Company, or by a nylon “VELCRO”® hook and fastener structure available from Velcro USA Inc. located in Manchester, N.H. The end of connector 60 opposite from base 62 has a pedestal section 68 that extends through aperture 70 in panel 24 to engage base 32 of members 30. The end of pedestal 68 is configured to abut ribs 34, and an annular projection 72 extending from the end of pedestal 68 is configured to be captured between longitudinal ribs 34 to improve lateral stability of members 30. Connectors 60 further include supports 74 (wings, braces, arms, etc.) to support the back surface of panel 24 in the proximity of aperture 70. In a preferred embodiment, connectors 160 and 60 are made from ABS, polycarbonate or other suitable plastic and spring clip 164 is made from heat-treated spring steel or wire, however, connectors 160 and 60 may have any shape and material composition appropriate for transferring the load from system 10 through members 30 to frame member 16, and connector 60 may be attached to frame member 16 by any suitable means providing the appropriate tensile strength. Connectors 160 and 60 have a spacer length corresponding to the gap 76 between frame member 16 and panel 24. Following panel 24 installation over pedestal 68 of connectors 60 in the vehicle, members 30 may be positioned over panel 24 and aligned with connectors 160 or 60, whereby members 30 are secured by a threaded fastener or 166 or 76 through base 32 and into connector 160 or 60. In alternative embodiments, other connector structures may be used such as solid blocks (not shown), and panel 24 may be provided without apertures 70 whereby a fastener penetrates the base, panel and the connector. In another alternative embodiment, members 30 may be bowed into a shallow arch-like profile (not shown) and installed with a compression fit between the forward and rearward ends of the roof frame, or other vehicle structure such as floor and roof panels, thus obviating or minimizing the need for mid-span connectors. Further, members 30 may be mounted against panel 24, or alternatively panel segments may be positioned around members 30.

Referring further to FIG. 1, a variety of articles 20 may be mounted to members 30 according to a preferred embodiment. Articles 20 may include storage compartments (with or without key-lock access control) tailored to hold tissues, sunglasses, remote control devices, wireless phones, pagers, personal data assistants (PDA), walkie-talkies, binoculars, cameras, first aid or road-side emergency kits, tools, baby-care products and supplies, arts and crafts supplies, toys, sporting goods, books, maps, hunting and fishing equipment, and many other articles for which readily accessible storage in a vehicle may be useful. Such storage compartments may either be fixed or designed for pull-down, drop-down or rotational access where the compartment is recessed during storage and extended for access during usage. Articles 20 may also include handles, brackets, fixtures (e.g. starter block) for mounting racks, cages, or support pillars for optionally receiving members 30 to mount additional articles 20 in a cargo area, lighting equipment, power adapters and outlets, lighters; visual display screens; audio equipment; media displays; digital video disc players; GPS receivers; cargo storage racks, straps or tie-downs; garment hangers, rods or racks; insulated hot or cold-storage containers, mobile office workstation components, portable air compressors or vacuum cleaners, cargo netting and holders; occupant safety features; specially-adapted consumer-use products such as travel tables, camping gear, pet barriers, luggage, etc.; brackets having rigid, swiveling or rotating couplers for removably receiving such consumer use products; storage racks having fixed or retractable support members for storing skis or other gear; and any other articles which may be useful in conjunction with traveling, working or other vehicle use.

Articles 20 are adapted to be selectively positionable along members 30, however, articles that may deemed to create a distraction to the vehicle operator, such as video displays and the like, are provided with a mounting interlock feature which prevents their installation in certain prohibited positions along the members, for example, allowing video monitors to be installed only in a rearward portion of the vehicle. The interlock function may be accomplished by altering the cross sectional shape or profile of a portion of the members (not shown) or providing a second recess and ledge (not shown). Particular articles 20 may be provided with a mounting profile for engaging members 30 that includes a projection (not shown) that extends into passage 50 whereby installation of a blank (not shown) within a particular portion of passage 50 along member 30 will prevent mounting such articles in the selected locations. Alternatively installation of articles may be selectively restricted by otherwise altering the profile of the members to fit only selected article mounting profiles and may be accomplished by adding a shim (not shown) along one or more sides of member 30 or in connection with the passageway of the member.

Articles 20 suitable for suspension from a single member are configured for attachment to a single member 30 by having means for releasably connecting to the recess 38 and ledge 40 on each side of a member 30. Articles 20 that are more suitable for suspension from two members 30 are configured having a first means on one side of the article for attaching to the recess 38 and ledge 40 on one or both sides of the first member 30, and are configured having a second means on the opposite side of the article for attaching to the recess 38 and ledge 40 on one or both sides of the second member.

Various components or methods may be used for attaching articles 20 to members 30 as described in U.S. Pat. No. 6,668,260, entitled “Modular System For A Vehicle,” issued Dec. 30, 2003 and herein incorporated by reference in its entirety.

As mentioned above, electrical articles installed in the vehicle, including those mounted to the modular system 10, are typically coupled to a power source as well as to other devices in the vehicle in order to transmit and/or receive data, audio, video and/or command and control signals. Such signals may be provided to and between electrical devices in a vehicle via a wired connection, for example, a vehicle bus. Modular system 10 may be configured to distribute power and data to/from the articles attached to members 30 of modular system 10. Referring to FIGS. 3 and 5, a utility interface 160 for system 10 is shown schematically according to a preferred embodiment. Interface 160 is included within the cover 12 for communicating with passageways through the roof structure (not shown) and interfacing with members 30. Interface 160 includes a series of ports 162 (e.g. connectors, receptacles, jacks, plugs, etc.) for facilitating the interconnection of conventional utility carriers 163 (e.g. wires, cables, conductors, harnesses, etc.) for delivering utilities (e.g. electrical power, voice and data communication signals, RF transmission signals, instrumentation signals, etc.) between a supply source (not shown) and articles 20 mounted to members 30. Utilities may be routed from the utility supply source (e.g. a battery, antenna, receiver, transmitter, etc.—not shown) through utility carriers 163 that interconnect the supply source and the ports 162 provided in interface 160. Utility interface 160 may be provided in either the forward or rearward portion of the vehicle.

Utilities may be distributed from interfaces 160 via additional utility carriers 164 that interconnect between interfaces 160 and articles 20. The utility carriers 164 may be distributed throughout system 10 by routing the carriers 164 through passage 50 in members 30 where the carriers 164 are concealed behind cover 54 (shown in FIG. 6) and articles 20. Articles 20 are mounted over members 30 and their covers segments 54, whereby one or more gaps or other openings corresponding to access and egress locations for utilities carriers 164, interfacing with articles 20 may be provided in cover 54, behind article 20, to create a utilities access pattern. The access pattern is adaptable to future changes or modifications in the article selection package by making suitable changes in the removable cover 54 of members 30. Articles 20 and utility carriers 164 may be provided with mating connectors 166 to facilitate ease of installation, replacement or reconfiguration of articles 20 within the system 10. Alternatively, articles 20 may be provided with a fixed length of utility carrier for routing through passage 50 to interface 160, where the carrier includes a terminal at the outward end configured for directly connecting with interface 160. To provide additional flexibility in distributing utilities to various articles, an article 20 may be configured to serve as a utility storage or junction box for housing additional utility distribution devices or components and for storing excess quantities of utility carrier that may be desirable for accommodating future changes to the article selection package.

Alternatively, as mentioned above with respect to FIGS. 5 and 6, a low-voltage electrical power in the range of approximately 12-42 volts DC or other suitable voltage range for powering articles 20 may be routed to articles 20 via members 30, where members 30 are fabricated entirely or partially from aluminum or other electrically conductive material. Members 30 may also be fabricated from a non-conducting material such as plastic, where a conducting material such as copper or aluminum is integrally formed with member 30 in the shape of a longitudinal conducting strip, rail or bar (not shown) to provide a uniform electric current access path from interface 160 to articles 20. Such conducting material may be affixed to member 30 by ultrasonic welding, molding, interference-type snap insert, or vacuum metallization. Articles 20 are provided with an electrically conductive contactor (not shown) that projects outwardly from a surface of article 20 and is configured to contact member 30 or a conducting strip thereon (not shown) and remains concealed between member 30 and article 20 when article 20 is installed on member 30 to provide a conductive electrical path to article 20. The contactor may be spring-biased for urging the contactor into continuous contact with member 30 or a conducting strip when article 20 is mounted on members 30. In a preferred embodiment where a system with two parallel members are used, one member 30 would have a positive electrical polarity (i.e. battery potential) and the second member 30 would have a negative electrical polarity (i.e. ground). For embodiments using a single member, two longitudinal conducting strips (not shown) may be used on member 30 to provide positive and negative conductors, corresponding to appropriately positioned contactors on an article 20 configured to mount to a single member 30.

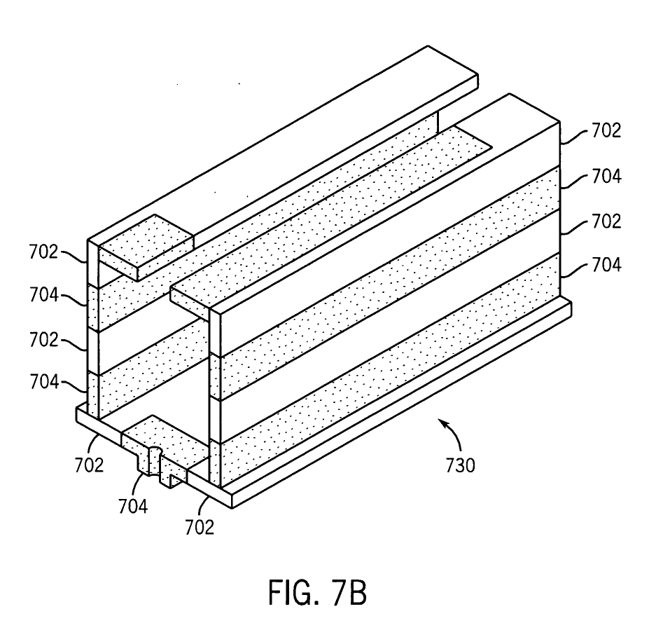

As mentioned previously, member(s) 30 may be fabricated entirely or partially from aluminum or other electrically conductive material and therefore act as a conductor for transmitting low voltage electrical power from a power source to articles mounted on members 30. Alternatively, other utilities may also be provide by a conductive member 30. One method to provide electrical connections to an article mounted to parallel members, as discussed above, involves providing one member with a positive electrical polarity (i.e. battery potential) and providing the second member with a negative electrical polarity i.e., ground). Alternatively, conducting strips may be used on a member 30 to provide positive and negative conductors. In another embodiment, a member or members is provided with segmented electrical portions corresponding to various electrical utilities (e.g., power, data, etc.). FIG. 7A is a cross-sectional view of a member of a modular system with segmented electrical portions in accordance with an embodiment. FIG. 7B is a perspective view of a member of a modular system with segmented electrical portions in accordance with an embodiment.

Referring to FIG. 7A, member 730 includes multiple electrical segments or portions 702 that each may provide electrical connections such as positive electrical polarity (e.g., +12 VDC), ground (e.g., −12 VDC), data signals (e.g., DATA1, DATA2, DATA3), etc.. Portions 704 of member 730 are non-conductive. Accordingly, multiple electrical connections may be provided on member 730. A single member or multiple members (e.g., parallel members) may each be configured to include multiple electrical portions 702. Each electrical portion 702 may be formed by extruding a dielectric material over portions of the conductive member 730. The dielectric material may be a polymer such as Poly Vinyl Chloride (PVC), ABS, a blend of polymers, or other appropriate polymer. The non-conductive portions 704 of member 730 may be, for example, fabricated from a non-conducting material or a non-conducting material or insulating cover may be provided to isolate the conductive material of member 730 from contact with an article. Electrical portions 702 may extend along the entire length of member 730 as shown in FIG. 7B. In an alternative embodiment, electrical portions 702 may be divided into segments along the length of member 730 in order to control which areas of member 730 is provided with power or other utilities. Alternatively, the electrical portions 702 may not run continuously along the entire length of the member 730, but only along certain portions of the entire length of member 730 (e.g., at positions on member 730 where an article may be located). As discussed above, it may de desirable to prevent the installation of certain articles (or any articles at all) in certain positions along members 730. For example, an article that may be deemed a distraction to the vehicle operator such as a video monitor may only be only be allowed to be installed in a rearward portion of the vehicle. Segments of electrical portions 702 may be selectively powered or an encoding may be implemented to identify whether an article may be connected at a particular location along the rail (i.e., to prevent unauthorized connection). A processor may be coupled to member 730 (e.g., a control module 812 as described in further detail below) to selectively power electrical portions of rail and/or to determine if an attached article has the proper code.

An article that may be mounted to member 730 will include contact points configured to contact the appropriate electrical portions 702. A member 730 with electrical portions 702 may be used to provide the multiple electrical circuit connections for various utilities for an article. The cross-sectional shape of member 730 shown in FIGS. 7A and 7B is exemplary and it should be understood that electrical segments or portions 702 may be provided for a variety of cross-sectional shapes of member 730.

Returning to FIGS. 3 and 5, in another embodiment, conducting strips may be used as an article positioning interlock along members 30 by altering the conducting strip longitudinal position along member 30 to provide a power interlock profile. The power interlock profile ensures that contactors for certain articles will properly interface with the conducting strips only when articles are installed at locations on members 30 corresponding to a mating conducting strip position. For example, video display articles may have contactors positioned to match a conducting strip position corresponding only to a location rearward of the front seats of the vehicle. Similarly, other consumer articles that may create a distraction to a vehicle operator may be electrically interlocked so that they are operable only when installed in positions that are pre-established by the power interlock profile. Insulating cover segments (not shown) may be provided that are adapted to cover portions of members 30 that remain exposed after installation of the article selection package to prevent consumer exposure or electrical shorts to ground with the energized portions of system 10.

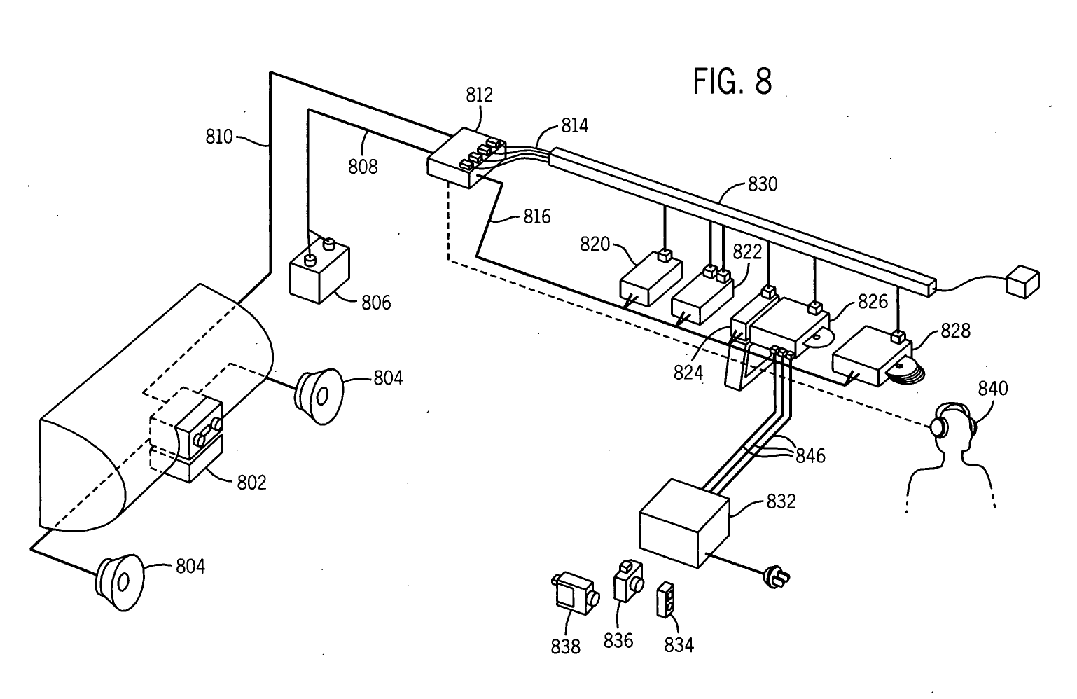

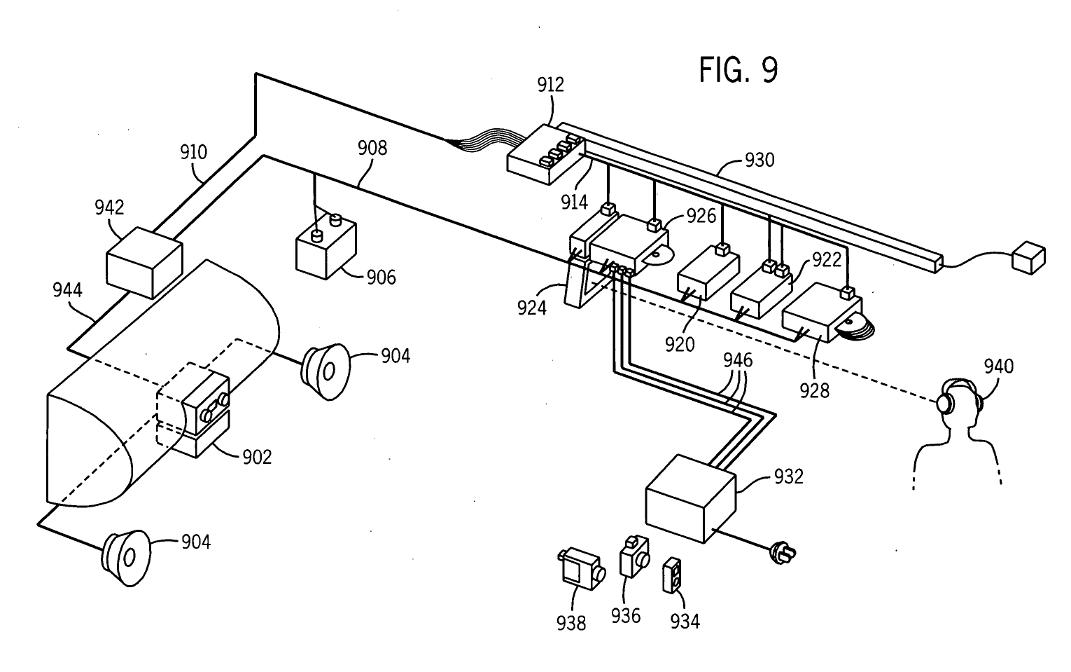

Each article 20 installed on modular system 10 as well as devices located elsewhere in the vehicle is typically controlled separately (e.g., using a user interface of each article or device) by an occupant of the vehicle. FIG. 8 is a block diagram of an electrical connectivity system for use in a vehicle in accordance with an embodiment. Conventional utility carriers 808, 810 (e.g., wires, cables, conductors, harnesses, fiber optics, etc.) are used to deliver utilities (e.g., power, data, audio, video and/or command and control signals) between a supply source (e.g., radio head 802, power source 806) and articles mounted on members 830. Radio head 802 includes an audio system (e.g., a radio, speakers 804, etc.) that is coupled to a utility carrier (e.g., an audio bus, a vehicle bus 942 (shown in FIG. 9)). Accordingly, information and signals from other devices in the vehicle that are coupled to the utility carrier may be accessed by radio head 802. Utility carrier 810 is coupled to radio head 802 and is configured to carry utilities such as data, audio, video, command signals, etc. between radio head 802 and a control module 812.

Control module 812 is coupled to members 830 of a modular system and a power source 806. Preferably, control module 812 is in a location visible and accessible to a driver of the vehicle, however, control module 812 may also be mounted in other locations in the vehicle (e.g., accessible to other vehicle occupants). Power source 806 (e.g., a battery) is connected to control module 812 via a conventional utility carrier 810. In an alternative embodiment, shown in FIG. 9, power source 906 is not coupled to a control module 912, but is coupled directly to the modular system (e.g., members 930 and/or articles coupled to the modular system) via a utility carrier 908. In other words, power is not directed through the control module 912 to the modular system. Returning to FIG. 8, radio head 802 (and/or vehicle bus 942 shown in FIG. 9) and control module 812 are configured to communicate via utility carrier(s) 810.

Power or data received by control module 812 from utility carriers 808, 810, respectively, are distributed from (or to) control module 812 via utility carriers 814 and 816 to (or from) articles (e.g., rear HVAC 820, XM radio 822, display 824, DVD player 826 and CD player 828) installed on members 830. Utility carriers 814, 816 interconnect between control module 812 and the articles mounted on members 830. As mentioned above, utility carriers 814, 816 may be distributed throughout the modular system by routing the carriers through a passage 50 (shown in FIG. 6) in members 830, where the carriers are concealed behind a cover 54 (shown in FIG. 6) and the articles. Articles are mounted to members 830 and may access utility carriers 814, 816 via, for example, one or more gaps or openings corresponding to access and egress locations for utility carriers 814, 816. As described above with respect to FIGS. 3 and 5, the articles and/or the utility carriers may be provided with a connector to facilitate installation.

Other electrical devices that are not installed or mounted to the vehicle, such as a video game system 832, an MP3 player, a digital camera 836 or a digital video camera 838, may be used in conjunction with an article, such as DVD player 826 and display 824, that is installed or mounted in the vehicle. As shown in FIGS. 8 and 9, an auxiliary input 846, 946 (e.g., a utility carrier) may be used to connect, for example, a video game system 832, 932 to DVD player 826, 926 and display 824, 924. In another embodiment, control module 812 (912 shown in FIG. 9) may be used as a conduit for communication between any articles located in the vehicle, including articles not mounted to a modular system but located elsewhere in the vehicle. Accordingly, control module 812, may be used to facilitate article to article communication in the vehicle. For example, a CD player mounted in a trunk may be coupled, either wired or wirelessly, to control module 812 which may be used to communicate, for example, audio or control signals between the CD player and a vehicle audio system.

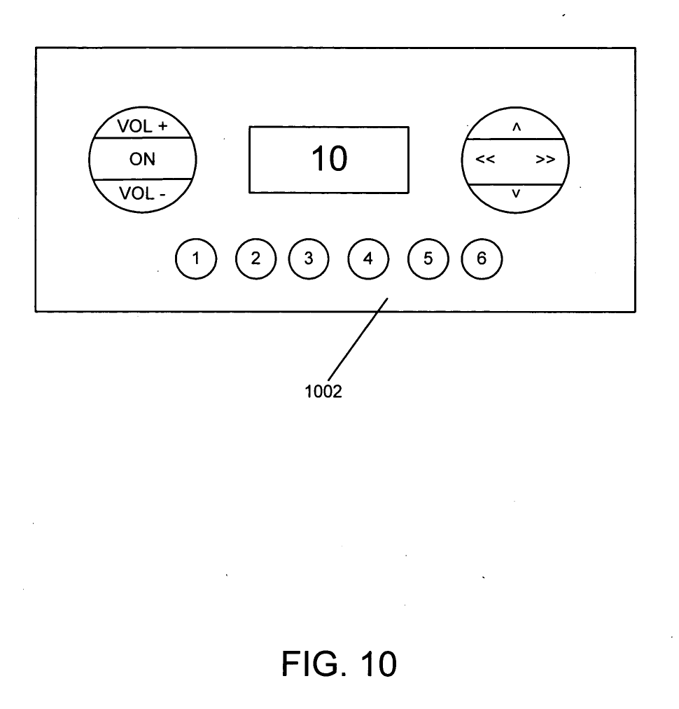

Control module 812 is configured to allow a user to select an article or device mounted to the modular system to be operated and to control the operation of the selected article. For example, a user may select to operate a DVD player 826. Control module 812 preferably includes a user interface (not shown) from which a user may provide command and control functions. FIG. 10 shows an exemplary user interface 1002 for control module 812. A user can control functions of the selected device such as Play, Stop, Volume, Disk/Track change, etc. using the user interface (e.g., buttons or switches) of control module 812. Accordingly, control module 812 provides a single user interface and point of control and access from which a vehicle occupant (e.g., a driver) can control all of the electrical devices or articles mounted to members 830 of the modular system. As mentioned previously, control module 812 may also be used to control the communication between articles in the vehicle that are not mounted to the modular system. Control module 812 may also be configured to control or select the distribution of utilities to articles in the vehicle. For example, control module 812 may provide a single point of access (or a gateway) for the articles on the modular system to the radio head 802 or other in-vehicle devices. All of the audio outputs of the articles mounted to members 830 are connected to control module 812 via utility carrier(s) 814 or wireless communication. Accordingly, a user can select which device or article is being heard over the vehicle speakers 804. In another embodiment, control module 812 may be configured to simultaneously broadcast a plurality of audio signals from the plurality of articles. The audio signals may be broadcast, e.g., by RF, IR or wired connections, to headphones 840 in the vehicle. Each set of headphones 840 includes a user interface (e.g., buttons, switches, a dial) to select one of the audio signals (e.g., channel A, B, or C) being simultaneously, broadcast in the vehicle cabin be control module 812. A user may, therefore, select an audio signal from one of a plurality of sources to listen to on headphones 840.

Control module 812 may be a stand alone module mounted to members 830 as shown in FIG. 8 or alternatively, control module 812 may be incorporated into another article. Control module may include various types of control circuitry, digital and/or analog, and may include a microprocessor, microcontroller, application-specific integrated circuit (ASIC), or other circuitry configured to perform various input/output, control, analysis, and other functions described herein. Utility carrier(s) 814 may be operated in accordance with a known standard or protocol that enables data, audio, video and command/control signals to be distributed to/from control module 812 to the articles mounted to members 830 so that the articles may be controlled from control module 812, for example, a CAN or LIN network. In an alternative embodiment, utilities (e.g., audio, command signals, control signals, etc.) may be transmitted wirelessly between control module 812 and articles (e.g., DVD player 826, Rear HVAC 820) using known wireless transmission protocols, for example, Infrared (IrDA), Bluetooth, Wireless LAN (IEEE 802.11) or 900 MHz FHSS. Accordingly, control module 812 and an article mounted to the modular system may be configured to communicate wirelessly.

Various articles (e.g., XM radio 822, a navigation system, etc.) mounted in the vehicle, such as on a modular system, may include a display for providing display information. However, if the article is mounted in the rear of the vehicle, the display information would not be visible to the driver of the vehicle. Accordingly, control module 812 may be configured to receive display information from an article and provide such display information on a display of the control module interface ( as shown in FIG. 10). Alternatively, the display information may be provided to another display in a viewable location in the front of the vehicle. Control module 812 may also be configured to provide other features, for example, an audio muting feature that allows an operator to mute the system audio (e.g., over the vehicle speakers or headphones) or a synchronization feature that provides synchronization between audio and video channels.

As mentioned previously, various utilities including audio signals may be distributed between electrical articles or devices in a vehicle via conventional utility carriers (e.g., audio signals may be sent between a CD player in the trunk and the radio head or between an article on a modular system and the radio head). Due to the location of electrical devices throughout a vehicle, utilities, such as analog audio signals, may need to be transmitted over a distance in the vehicle, for example, from a rear seat device to a radio head at the front of the vehicle or through a modular system to the radio head. A system for transmitting multiple analog audio signals may include multiple wires, analog to digital and digital to analog converters and a multimedia digital data bus (e.g., IDB-1013 or MOST).

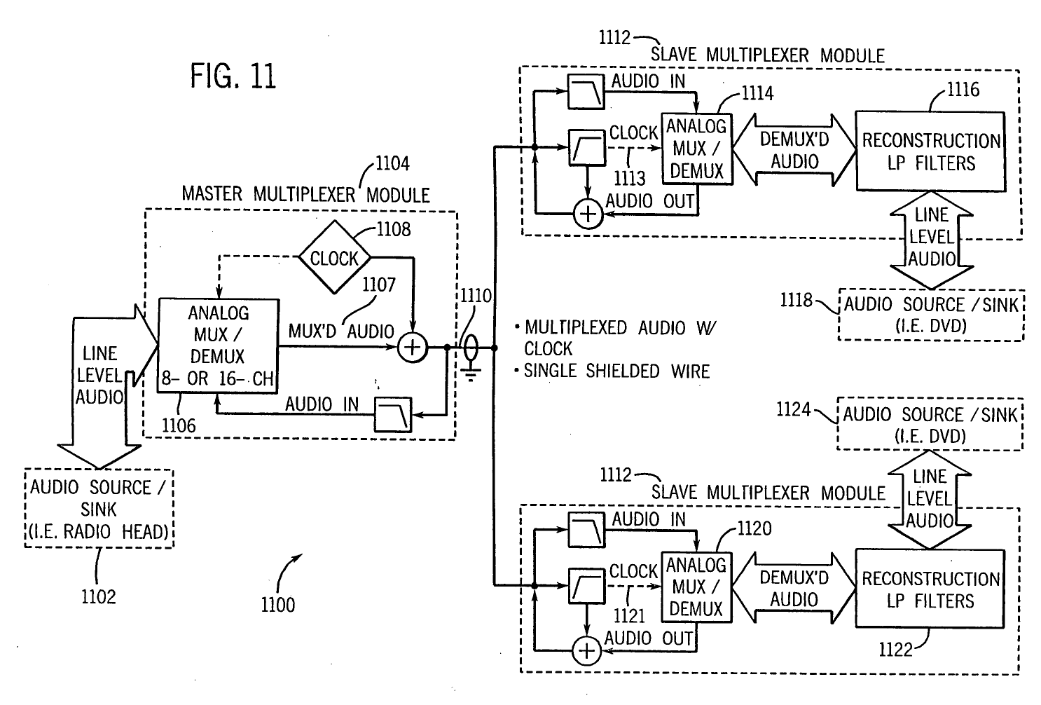

The system 1100 shown in FIG. 11 allows the transmission of a plurality of analog audio signals to multiple devices or articles in a vehicle. An analog multiplexer/demultiplexer is used to combine a plurality of analog audio signals (or channels) onto a single wire 1110 routed to multiple articles or devices in the vehicle. In one embodiment, up to sixteen analog audio channels are combined onto the single wire 1110. Preferably, wire 1110 is a shielded wire that acts as the physical audio bus. The system reduces the size of the wire bundles required to distribute analog audio signals to devices throughout the vehicle. In addition, A/D converters, D/A converters and multimedia digital data buses are not required for transmission of the analog audio signals.

An audio source 1102 (e.g., a radio head) is coupled to a master multiplexer module 1104. Audio source 1102 provides analog audio signals to and receives analog audio signals from master multiplexer module 1104. Master multiplexer module 1104 is coupled to a single shielded wire 1110 that is coupled to multiple slave multiplexer modules 1112. Preferably, each slave multiplexer module 1112 is coupled to other audio sources (or devices) 1118, 1124 (e.g., a DVD player) in the vehicle which would communicate audio signals with the radio head. Master multiplexer module 1104 and slave multiplexer modules 1112 act as interfaces between the audio sources 1102, 1118, 1124 and the single wire audio bus 1110 used for transmission of analog audio signals between audio devices.

Master multiplexer module 1104 includes an analog multiplexer/demultiplexer circuit 1106 that is used to combine separate audio signals together in a single multi-channel signal 1107. A clock signal 1108 is generated by master multiplexer module 1104 and is used to synchronize the slave multiplexer modules 1112. The multiplexed audio signals 1107 are summed with the clock signal 1108 and sent on the single wire audio bus 1110. Multiplexer/demultiplexer circuit 1106 may also receive analog audio signals from the single wire audio bus 1110 and may be used to separate out audio signals that may be provided to audio source 1102.

Multiplexed audio signals transmitter on the single wire audio bus 1110 are received at a slave multiplexer module 1112. At a slave multiplexer module 1112, the clock signal and multiplexed analog audio signals are separated using high pass and low pass filters (not shown). Once the clock and multiplexed audio signals are separated, an analog multiplexer/demultiplexer circuit 1114, 1120 is used to separate out the audio signals. Low pass reconstructions filters 1116, 1122 may be applied to each audio signal to remove noise associated with the sampling and multiplexing process. The audio signal(s) may then be provided to an audio device 1118, 1124. The multiplexer/demultiplexer circuits 1114, 1120 in the slave multiplexer modules 1112 may also receive audio signals from an audio source 1118, 1124 to be transmitted on the single wire audio bus 1110. As discussed above, multiple audio signals may be combined by multiplexer/demultiplexer circuit 1114, 1120 into a single multi-channel signal that is summed with the clock signal 1113, 1121 before being sent on the single wire audio bus 1110.

In another embodiment, the system 1100 may be configured to be bi-directional so that audio signals may be sent in both directions (e.g., to/from the radio head) on the same wire. This would allow, for example, audio to be provided from the radio head to an article mounted on a modular system or vice versa so that a passenger could have the option to listen to either the vehicle radio or the article mounted to the modular system on, for example, a set of headphones. In order to transmit audio signal bi-directionally on the same wire 1110, each channel would be defined as one direction or the other.

It is important to note that the construction and arrangement of the electrical connectivity system and modular system and devices as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited herein. Accordingly, all such modifications are intended to be included within the scope of the present invention as described herein. The order or sequence of any processes or method steps may be varied or re-sequenced according to alternative embodiments. Other substitutions, modifications, changes and/or omissions may be made in the design, operating conditions and arrangement of the preferred and other exemplary embodiments without departing from the exemplary embodiments of the present invention as expressed herein.

We claim:

1. An electrical connectivity system for use in a vehicle, the system comprising:
a first plurality of electrical devices coupled to at least one utility carrier, the first plurality of electrical devices configured to communicate a plurality of utilities on the at least one utility carrier; and
a control module coupled to the at least one utility carrier and a second plurality of electrical devices, the control module configured to control the selection and distribution of the plurality of utilities to the second plurality of electrical devices, the control module having a user interface configured to receive user input commands regarding the selection of utilities distributed to the second plurality of electrical devices.

2. A system according to claim 1, wherein the second plurality of electrical devices are mounted to a modular system in the vehicle.

3. A system according to claim 1, wherein the control module is mounted to a modular system in the vehicle.

4. A system according to claim 1, wherein the plurality of utilities includes at least one of data signals, audio signals or video signals.

5. A system according to claim 1, wherein the control module is further configured to control the delivery of utility signals between the second plurality of electrical devices and the first plurality of electrical devices.

6. An electrical connectivity system for use in a vehicle, the system comprising:
a first plurality of electrical devices coupled to at least one utility carrier, the first plurality of electrical devices configured to communicate a plurality of utilities on the at least one utility carrier; and
a control module coupled to the at least one utility carrier and a second plurality of electrical devices, the control module configured to control the operation of each device in the second plurality of electrical devices, the control module having a user interface configured to receive user input commands regarding the operation of at least one device of the second plurality of electrical devices.

7. An electrical connectivity system according to claim 6, wherein the second plurality of electrical devices are mounted to a modular system in the vehicle.

8. An electrical connectivity system according to claim 6, wherein the control module is mounted to a modular system in the vehicle.

9. An electrical connectivity system according to claim 6, wherein the first plurality of electrical devices includes a power source.

10. An electrical connectivity system according to claim 9, wherein the at least one utility carrier includes a utility carrier for power.

11. An electrical connectivity system according to claim 6, wherein the plurality of utilities includes at least one of data signals, audio signals, video signals or control signals.

12. A system for transmission of multiple analog audio signals in a vehicle, the system comprising:
a first audio device;
a first multiplexer module coupled to the first audio device and configured to combine a plurality of analog audio signals into a multi-channel audio signal;
a single wire audio bus coupled to the first multiplexer module and configured to carry the multi-channel audio signal provided by the first multiplexer module; and
a second multiplexer module coupled to the single wire audio bus and a second audio device, the second multiplexer module configured to receive the multi-channel audio signal, separate the plurality of analog audio signals in the multi-channel audio signal and provide at least one analog audio signal to the second audio device.

13. A system according to claim 12, wherein the single wire audio bus is further configured to bi-directionally communicate analog audio signals between the first audio device and the second audio device.

14. A system according to claim 13, wherein each channel of the multi-channel audio signal is defined to communicate audio signals in a direction.

15. A system according to claim 12, wherein the first multiplexer module includes a first multiplexer/demulitplexer circuit.

16. A system according to claim 12, wherein the second multiplexer module includes a second multiplexer/demulitplexer circuit.

17. A method for providing electrical connections in a modular system in a vehicle, the modular system including one or more elongated members adapted to be coupled to an interior portion of the vehicle, the method comprising:
providing a plurality of conductive segments on each elongated member; and
providing a plurality of non-conductive segments on each elongated member.

18. A method according to claim 17, wherein the plurality of conductive segments are formed by providing a conductive material on an elongated member at each conductive segment.

19. A method according to claim 17, wherein the plurality of non-conductive segments are formed by providing a non-conductive material on an elongated member at each non-conductive segment.
